(19) United States
(12) Patent Application Publication
(10) Pub. No.: US 2014/0301718 A1
(43) Pub. Date: Oct. 9, 2014

(54) RECORDING AND REPRODUCING APPARATUS

(71) Applicant: FUNAI ELECTRIC CO., LTD., Osaka (JP)

(72) Inventor: Hironobu Takahashi, Osaka (JP)

(73) Assignee: FUNAI ELECTRIC CO., LTD., Osaka (JP)

(21) Appl. No.: 14/243,002

(22) Filed: Apr. 2, 2014

(30) Foreign Application Priority Data
Apr. 8, 2013 (JP) 2013-080659

(51) Int. Cl. G11B 19/02; H04N 5/76

(52) U.S. Cl. CPC G11B 19/02; H04N 5/76
USPC 386/291

(57) ABSTRACT

A recording and reproducing apparatus that is capable of performing continuous recording includes a receiver that receives broadcasting programs, a recorder on which the broadcasting programs received by the receiver are recorded, a reproducer that reproduces the broadcasting programs recorded on the recorder, and a controller that determines which broadcasting program among the broadcasting programs recorded on the recorder is reproduced by the reproducer, and controls the continuous recording on a basis of record information of the broadcasting program reproduced by the reproducer.

This application is based on Japanese Patent Application No. 2013-080659 filed on Apr. 8, 2013, the contents of which are hereby incorporated by reference.

### BACKGROUND OF THE INVENTION

1. Field of the Invention

The present invention relates to a recording and reproducing apparatus, and in particular relates to a recording and reproducing apparatus having a power consumption saving function.

2. Description of the Related Art

In recent years, multi-functionalization of recording and reproducing apparatuses has been in progress, and in particular, recording and reproducing apparatuses having a function to perform a long-time continuous operation have been put in practical use. For example, there has been put in practical use a recording and reproducing apparatus that is provided with a plurality of tuners and a continuous recording function that allows a 24-hour non-stop recording by a continuous operation of the plurality of tuners.

However, such a long-time continuous operation as mentioned above leads to an increase in power consumption. Some programs recorded during a continuous recording may not suit a user's taste, and such programs may be ignored without being viewed. Thus, such a long-time continuous operation is not worth the total amount of power consumed during the continuous operation, which makes it a disadvantageously inefficient operation.

In relation to the above description, there has been disclosed and proposed a technology in which, when the number of channels selected at the time of default setting is smaller than the number of tuners, each selected channel is assigned to one of the tuners and operation of such a tuner as is assigned no selected channel is stopped (see, for example, JP-A-2011-055154).

However, the above-mentioned patent literature merely discloses a technology of achieving power saving on the basis of a setting result at the time of default setting, and does not disclose or suggest a technology of achieving power saving according to a user's history of viewing programs by reproducing recorded data of the programs.

### SUMMARY OF THE INVENTION

An object of the present invention is to provide a recording and reproducing apparatus that is capable of performing long-time continuous recording and that is capable of achieving power saving according to a user's viewing history.

To achieve the above object, according to the present invention, a recording and reproducing apparatus capable of performing continuous recording includes a receiver that receives broadcasting programs, a recorder on which the broadcasting programs received by the receiver are recorded, a reproducer that reproduces the broadcasting programs recorded on the recorder, and a controller that determines which broadcasting program among the broadcasting programs recorded on the recorder is reproduced by the reproducer, and controls the continuous recording on a basis of record information of the broadcasting program reproduced by the reproducer.

With this configuration, it is possible to control the continuous recording according to the viewing history of a user, and this makes it possible to achieve power saving by, for example, recording only programs that are likely to be viewed by the user without selecting programs that are not likely to be viewed by the user as targets to be recorded.

In the recording and reproducing apparatus according to the present invention, it is preferable that the controller control the continuous recording on the basis of broadcast time when recording of the broadcasting program reproduced by the reproducer has taken place.

With this configuration, it is possible to achieve power saving by, for example, recording only programs that are to be broadcast in time periods when the user is likely to view programs without selecting, as targets to be recorded, programs that are to be broadcast in time periods when the user is not likely to view programs.

In the recording and reproducing apparatus according to the present invention, it is preferable that the receiver include a plurality of tuners capable of simultaneously receiving a plurality of broadcasting programs, and that the controller control the continuous recording on the basis of a channel on which the recording of the broadcasting program reproduced by the reproducer has been performed.

With this configuration, it is possible to achieve power saving by, for example, recording only programs broadcast on channels that are likely to be viewed by the user without selecting, as targets to be recorded, programs to be broadcast on channels that are not likely to be viewed by the user.

In the recording and reproducing apparatus according to the present invention, it is preferable that the receiver and the recorder include a plurality of recording systems to which operational priorities are assigned, that the controller include a summarization unit and an operation control unit, that the summarization unit summarize history information indicating the broadcast time and the channel when and where the recording of the broadcasting program reproduced by the reproducer has been performed, and, on the basis of a result of summarizing the history information, the summarization unit classify the history information as first information when a counted number exceeds a predetermined threshold value, and classify the history information as second information when the counted number does not exceed the predetermined threshold value, and that, on the basis of a number of channels indicated in the first information and the operational priorities, the operation control unit determine which of the recording systems is to be assigned to a channel on which recording of a broadcasting program has been performed.

With this configuration, the recording systems are separated into those to which are assigned channels that broadcast a large number of programs that the user is very likely to reproduce and those to which are assigned channels that broadcast only a small number of such programs. This makes it more possible, in a case, for example, where one same device is included in two or more of the recording systems, to turn off a power supply of the one same device by exclusively assigning the channels that broadcast only a small number of such programs to the two or more of the recording systems.

In the recording and reproducing apparatus according to the present invention, it is preferable that the operation control unit assign channels to the recording systems in descending order of frequency of appearance in the first information such that first a channel having highest frequency of appearance in the first information is assigned to a recording system among the recording systems that is highest in the operational priorities.

This configuration makes it possible to preferentially turn off the power supply of a recording system assigned to a channel having many programs that the user is not very likely to reproduce.

In the recording and reproducing apparatus according to the present invention, it is preferable that the operation control unit determine whether to turn on or off a power supply of each of the recording systems with respect to each unit time period on the basis of the operational priorities and a channel indicated in the first information.

This configuration makes it possible to individually change ON/OFF states of power supplies of the recording systems with respect to each time period.

It is preferable that the recording and reproducing apparatus according to the present invention further include a setting unit that receives a power saving setting related to whether or not to give priority to power saving, and that the operation control unit change the threshold value according to the power saving setting.

This configuration makes it possible for the user to select whether or not to give priority to power saving, making it possible to achieve power saving as required by the user.

In the recording and reproducing apparatus according to the present invention, it is preferable that the operation control unit control the receiver and the recorder to turn on the power supply of a device that is among devices included in the recording system the power supply of which is determine to be turned off, and that is shared with the recording system the power supply of which is determined to be turned on.

With this configuration, in a case where a device is shared by a plurality of recording systems, it is possible to prevent the power supply of a device necessary for recording from being turned off.

### DESCRIPTION OF THE DRAWINGS

FIG. 1 is a block diagram showing an internal configuration of a recording and reproducing apparatus according to one embodiment of the present invention;

FIG. 2 is a block diagram showing a configuration of function units according to one embodiment of the present invention;

FIG. 3 is a flow chart showing sampling processing according to one embodiment of the present invention;

FIG. 4 is a flow chart showing operation control processing according to one embodiment of the present invention;

FIG. 5 is a schematic diagram showing device systems according to one embodiment of the present invention;

FIG. 6 is a schematic diagram showing a result of viewing-frequency sampling according to one embodiment of the present invention;

FIG. 7 is a schematic diagram showing a result of viewing-frequency sampling according to one embodiment of the present invention;

FIG. 8 is a schematic diagram showing a result of viewing-frequency sampling according to one embodiment of the present invention;

FIG. 9 is a schematic diagram showing a power supply stopping device according to one embodiment of the present invention; and

FIG. 10 is a schematic diagram showing a power supply stopping device according to one embodiment of the present invention.

### DESCRIPTION OF THE PREFERRED EMBODIMENTS

Embodiments of the present invention will be described below with reference to accompanying drawings. The embodiments described herein are examples, and the present invention is not limited to the embodiments described herein.

<1. Internal Configuration>

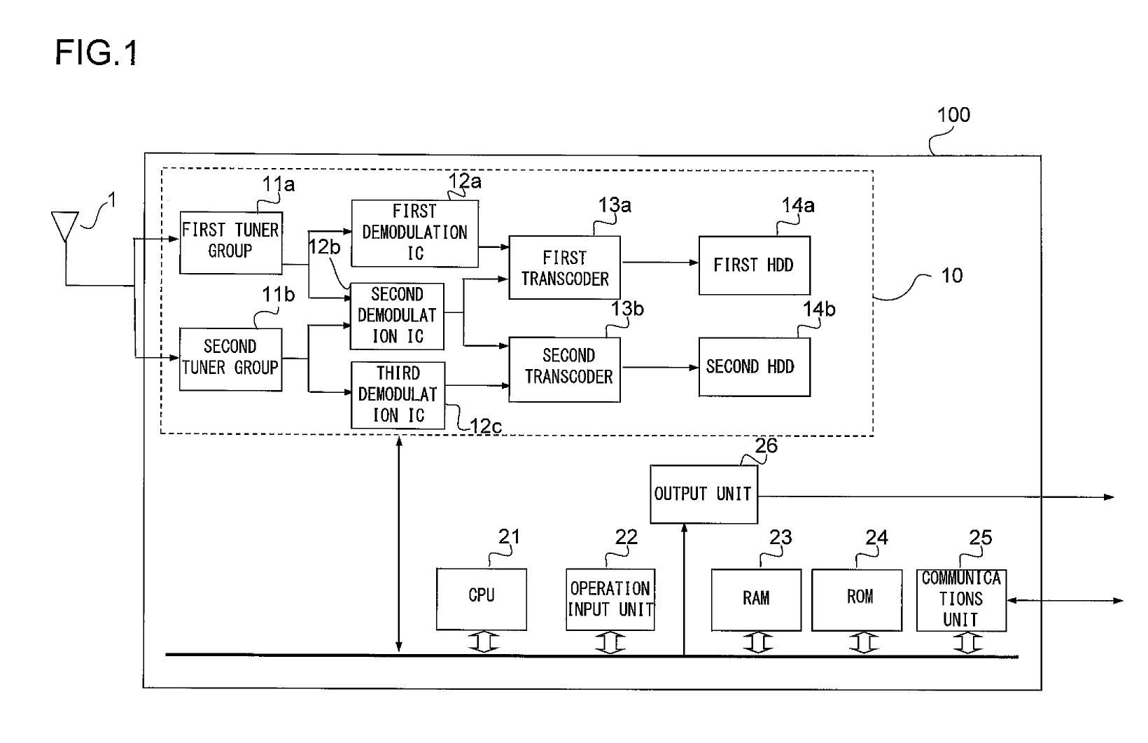

FIG. 1 is a block diagram showing an internal configuration of an HDD recorder 100 (an example of a recording and reproducing apparatus) according to one embodiment of the present invention. As shown in the block diagram of FIG. 1, an antenna 1 is externally connected to the HDD recorder 100 of the present invention.

The HDD recorder 100 at least includes the following elements that constitute a recording device group 10 (an example of a recorder): a first tuner group 11a (an example of a receiver), a second tuner group 11b, a first demodulation IC 12a (an example of a demodulator), a second demodulation IC 12b, a third demodulation IC 12c, a first transcoder 13a, a second transcoder 13b, a first HDD 14a (an example of a recorder), and a second HDD 14b. The HDD recorder 100 is also provided with a CPU 21, an operation input unit 22, an RAM 23, an ROM 24, a communications unit 25, and an output unit 26.

The recording device group 10 receives terrestrial digital television broadcasting signals via the antenna 1, demodulates the signals to acquire audio and video data, and records the acquired audio and video data. The recording device group 10, which includes a plurality of tuners and a plurality of demodulation ICs, is used to continuously record a plurality of channels by using the tuners and the demodulation ICs.

It should be noted that the recording device group 10 of this embodiment is a dedicated recording device group that is used only for continuous recording, and that normal recording processing that is manually requested by a user, timer recording processing performed by using an electronic program guide (EPG), and the like are performed by another recording device group that is not illustrated.

The first tuner group 11a and the second tuner group 11b (these will hereafter be collectively referred to as a “tuner group 11”) are each provided with a plurality of tuners which are not illustrated. The tuners receive a terrestrial digital television broadcasting signal via the antenna 1, and perform tuning to a desired physical channel. Note that the tuners included in the tuner group 11 cannot be turned on/off on a one-by-one basis, but they can be turned on/off all together as the tuner group 11.

According to this embodiment, each tuner group included in the tuner group 11 has three tuners. With this configuration, it is possible to simultaneously perform continuous recording of up to six channels by simultaneously operating the two tuner groups 11. Which channel is to be assigned to which tuner is determined through viewing frequency determination processing, which will be described later.

The first demodulation IC 12a, the second demodulation IC 12b, and the third demodulation IC 12c (these will hereafter be collectively referred to as a “demodulation IC 12”) perform demodulation and error correction for the tuned signals fed from the tuners, and output a transport stream (TS).

The first transcoder 13a and the second transcoder 13b (these will hereafter be collectively referred to as a “transcoder 13”) receive the TS demodulated by the demodulation IC 12, and perform predetermined conversion processing to change a data size.

The transcoder 13 reduces the data size, by, for example, lowering a resolution of video data without changing a decode format, or by performing lossy compression using an operation method with a small amount of inter-frame prediction information.

The first HDD 14a and the second HDD 14b (these will hereafter be collectively referred to as an “HDD 14”) are magnetic recording media for recording digital data. The HDD 14 records data or reads out data by moving a head with an actuator while rotating a plurality of magnetic disks. In the present embodiment, the HDD 14 is used for recording the TS generated by the demodulation IC 12 or digital data a data size of which has been reduced by the transcoder 13.

The CPU 21 is a processing unit that performs various operations, processing, and control. The CPU 21 organically controls driving of each member of the HDD recorder 100, and performs integrated control of processing such as broadcast receiving processing, viewing frequency determination processing, and operation control processing, which will be described later. The details of each function realized by the CPU 21 will be mentioned later.

The operation input unit 22 includes a remote control unit and a remote control light receiving unit, which are not illustrated. The remote control unit includes a push button, a touch sensor, and the like via which are given instructions such as a tuning instruction to the HDD recorder 100. The operation input unit 22 further includes a hard key unit, a touch panel unit, and the like, which are disposed on a housing of the HDD recorder 100. The operation input unit 22 generates and outputs an operation signal according to an operation performed by the user and accepted by any of the units included therein. It should be noted that the operation input unit 22 does not necessarily need to include all of these units, and the operation input unit 22 may include just some of them.

The RAM 23 is used, for example, as a work memory for the CPU 21. The ROM 24 stores, for example, control programs that the CPU 21 runs.

The communications unit 25, for example, includes communication interfaces such as a network connection terminal based on IEEE 802.3 standard and a wireless LAN board. By using these communication interfaces, the communications unit 25 achieves connection between the HDD recorder 100 and external devices such as a personal computer and a tablet computer which are not illustrated, and performs output and input of digital signals. This makes it possible to achieve video/audio distribution by, for example, the DLNA function, remote controlling of the HDD recorder 100 by using the tablet computer, and the like.

The output unit 26 includes an audio output terminal to which an audio device such as a speaker is connected to receive an audio signal therefrom, a video output terminal to which a display device such as a liquid crystal panel is connected to receive a video signal therefrom, and the like.

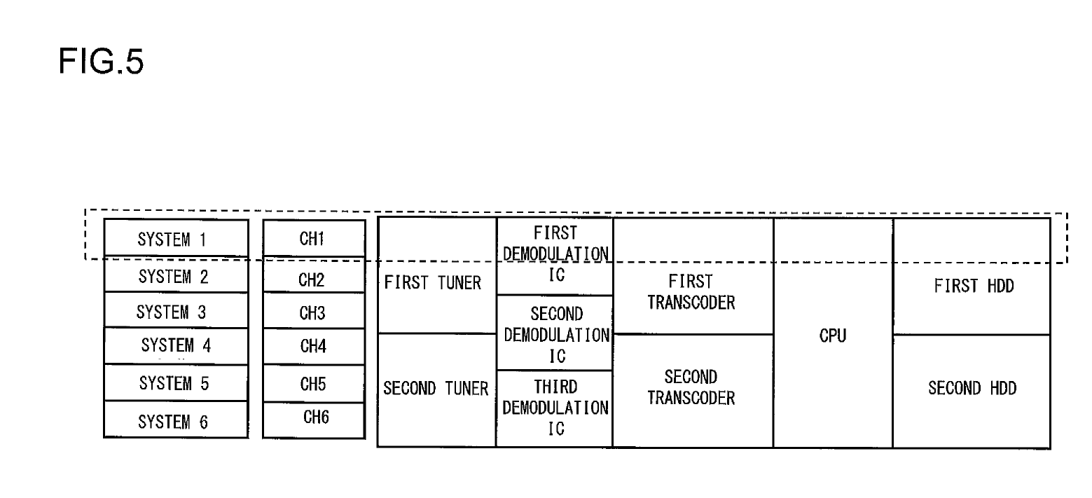

Among the above-described devices, recording systems (hereafter referred to as “device systems”) of the devices related to recording processing will be described with reference to FIG. 5. FIG. 5 is a schematic diagram showing an example of the device systems. In FIG. 5, a portion indicated by being enclosed with a broken line is one device system, and there exist a total of six device systems.

As shown in FIG. 5, there is a case where one device is shared by a plurality of device systems. For example, the first tuner group 11a is shared by three device systems, namely, device system 1, device system 2, and device system 3. Further, the first demodulation IC 12a is shared by two device systems, namely, device system 1 and device system 2.

Each device system has a channel for continuous recording assigned thereto. Thus, there is a case where different recording channels (receiving channels) is continuously recorded by using a common device, as in the case of CH1 and CH2. Assignment of the recording channels to the device systems is determined through the operation control processing, which will be described later.

<2. Configurations of Function Units>

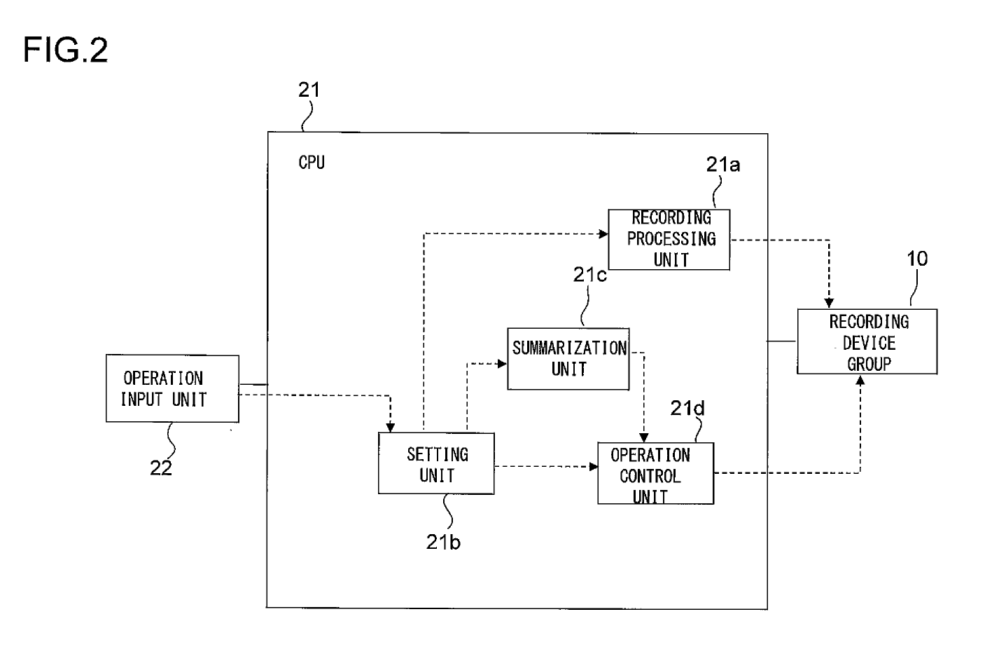

Here, a description will be given of a relation between the function units for performing the viewing frequency determination processing and the operation control processing according to one embodiment of the present invention, with reference to the functional block diagram of FIG. 2. Note that, in FIG. 2, functional blocks illustrated inside the CPU 21 each indicate a function unit realized when the CPU 21 runs a predetermined program.

The broken line arrow in FIG. 2 indicates a control-signal flow. As shown in FIG. 2, the viewing frequency determination processing and the operation control processing of the present embodiment are executed by a recording processing unit 21a, a setting unit 21b, a summarization unit 21c, and an operation control unit 21d.

The recording processing unit 21a performs processing of recording a predetermined channel continuously for 24 hours (hereafter referred to as “continuous recording”) by using the recording device group 10. The recording processing unit 21a performs control such as tuning control on the tuner group 11 and conversion control on the transcoder 13, and continuously records recording data on the HDD 14, to thereby perform continuous recording.

The setting unit 21b receives various settings regarding the continuous recording from the operation input unit 22. Examples of setting items that the setting unit 21b receives are as follows: a specification of a channel for the continuous recording; a specification of whether or not to use a power saving function in the continuous recording; and a specification of whether priority is to be given to power saving or recording in a case where the power saving function is used in the continuous recording.

The various settings received by the setting unit 21b are recorded on a predetermined recording medium (for example, the RAM 23), and the function units refer to the recorded settings.

The summarization unit 21c counts how many times the user views reproduced information (hereafter referred to as “recorded content”) recorded by the recording processing unit 21a in the continuous recording. More specifically, when a piece of recorded content is reproduced, a recording time period and a recording channel in and on which the recording of the piece of recorded content has been performed are checked, and history information (hereafter referred to as a “sample”) indicating the recording time period and the recording channel is recorded.

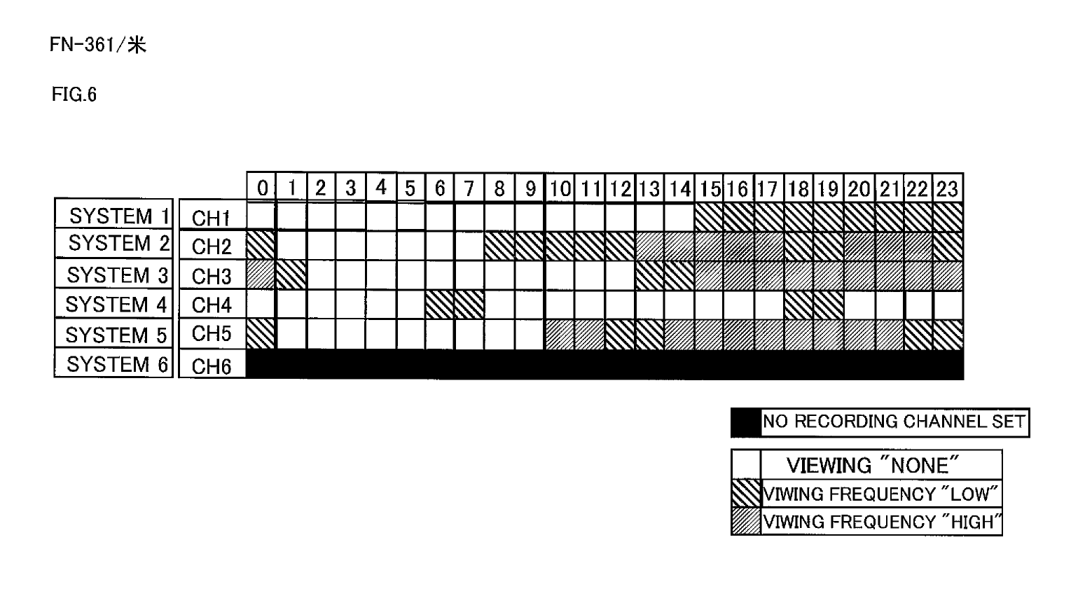

The summarization unit 2k also summarizes a sample recorded in a predetermined period. Then, according to a viewing frequency table shown in FIG. 6, each recording time period of each recording channel is classified with respect to the viewing frequency into three classes of “high”, “low”, and “none”.

In FIG. 6, a transverse direction indicates time, and one day is divided into 24 time periods of from 0:00 time period to 23:00 time period. Thereby, the viewing frequency determination processing is performed to determine a recording time period and a recording channel when and where a program that the user desires is likely to be broadcast. Details of the viewing frequency determination processing will be described later.

The operation control unit 21d performs ON/OFF control (hereafter referred to as the “operation control processing”) of a power supply of each device included in the recording device group 10 on the basis of a summarization result of the summarization unit 21c. Details of the operation control processing will be described later.

<3. Viewing Frequency Determination Processing>

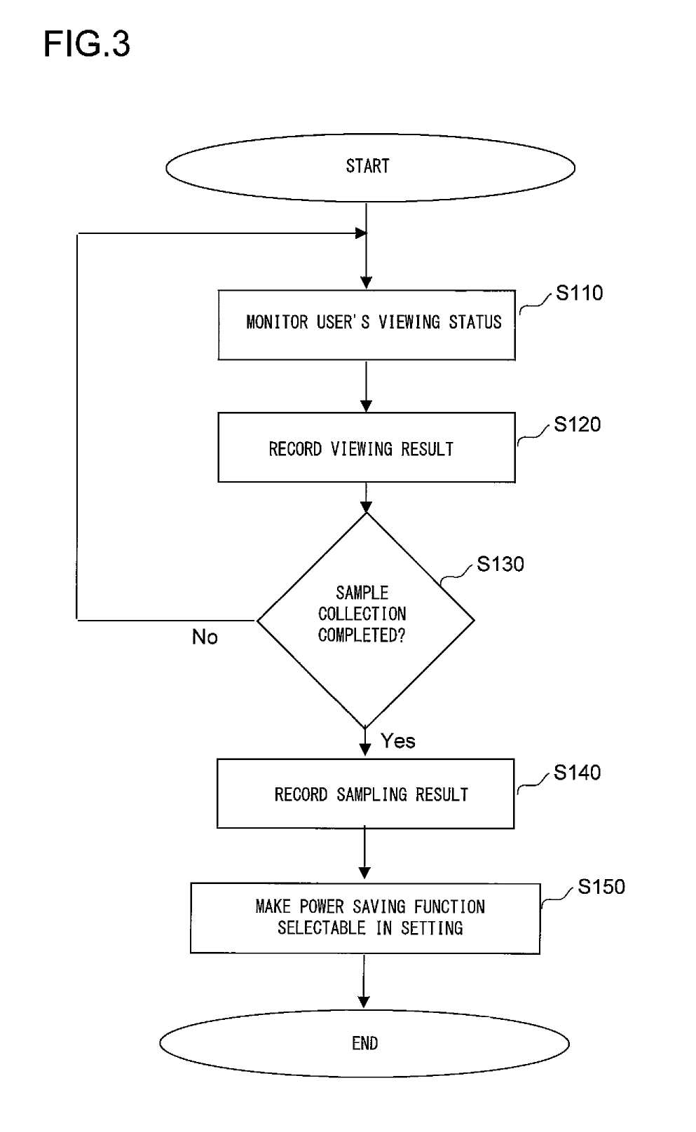

Here, with reference to the flow chart of FIG. 3, a description will be given of the viewing frequency determination processing executed by the HDD recorder 100 according to one embodiment of the present invention.

A processing flow of the present embodiment is started at a time point when the power supply of the HDD recorder 100 is turned on. After the present processing is started, in step S110, the summarization unit 2k monitors how the user views the recorded content. In other words, the summarization unit 21c monitors whether or not the recorded content recorded on the HDD 14 by the continuous recording is reproduced. It should be noted that reproduction of content recorded on the HDD 14 by a recording operation other than the continuous recording is not a target of the monitoring by the summarization unit 21c.

When reproduction of a piece of recorded content is detected, in step S120, the summarization unit 21c generates and records a sample indicating the recording time period and the recording channel of the reproduced piece of recorded content.

Next, in step S130, the summarization unit 21c determines whether or not sample collection has been completed on the basis of a predetermined condition. In the present embodiment, when one month's samples are collected, the summarization unit 21c determines that the sample collection has been completed. In a case where the sample collection has not been completed, the summarization unit 21c goes back to step S110.

In a case where the sample collection has been completed, the summarization unit 21c summarizes the samples (hereafter referred to as “sampling”). FIG. 6 to FIG. 8 are each a schematic diagram showing an example of the viewing frequency table for performing this sampling.

In the viewing frequency table, rows of the device systems to which the recording channels are assigned are each divided into time periods of a predetermined unit length (one hour in the present embodiment). FIG. 6 shows an example where six rows are provided for the device systems and 24 columns are provided for the unit time periods, so that the viewing frequency table includes 144(6×24) cells.

For example, when a sample indicates CH2 as the recording channel and time period from 14:00 to 15:00, one flag is set on the 15th cell of the second row. Flags are accumulated and recorded.

The summarization unit 21c calculates the number of flags set on each of the cells, and evaluates the cells based on the calculated number of flags on a scale of a plurality of levels such as “high”, “low”, and “none”. Thereby, a viewing pattern of the user is learned.

For example, by setting “five” as a threshold value between “high” and “low”, a cell where five or more flags are set is classified as “high” while a cell where fewer than five flags are set is classified as “low”. The threshold value may be changed as necessary according to, for example, a design matter.

Note that “no recording channel set” in FIG. 6 indicates a device system to which no recording channel is assigned, or a device system to which is assigned a recording channel that is not a target of the continuous recording.

Next, in step S140, the summarization unit 21c records the viewing frequency table that reflects the result of the sampling performed as described above on a predetermined recording medium (for example, the RAM 23).

Next, in step S150, the setting unit 21b displays, in a setting menu displayed on an on-screen display (OSD) or the like, a setting item for the power saving function in the continuous recording in addition to a setting item related to power saving. This is because it is impossible to execute the power saving function with a default setting menu that does not have an accumulation of the above-described viewing pattern of the user. In the case where the power saving function is not able to be executed, the setting item for the function may be greyed out to indicate that it cannot be selected.

<4. Operation Control Processing>

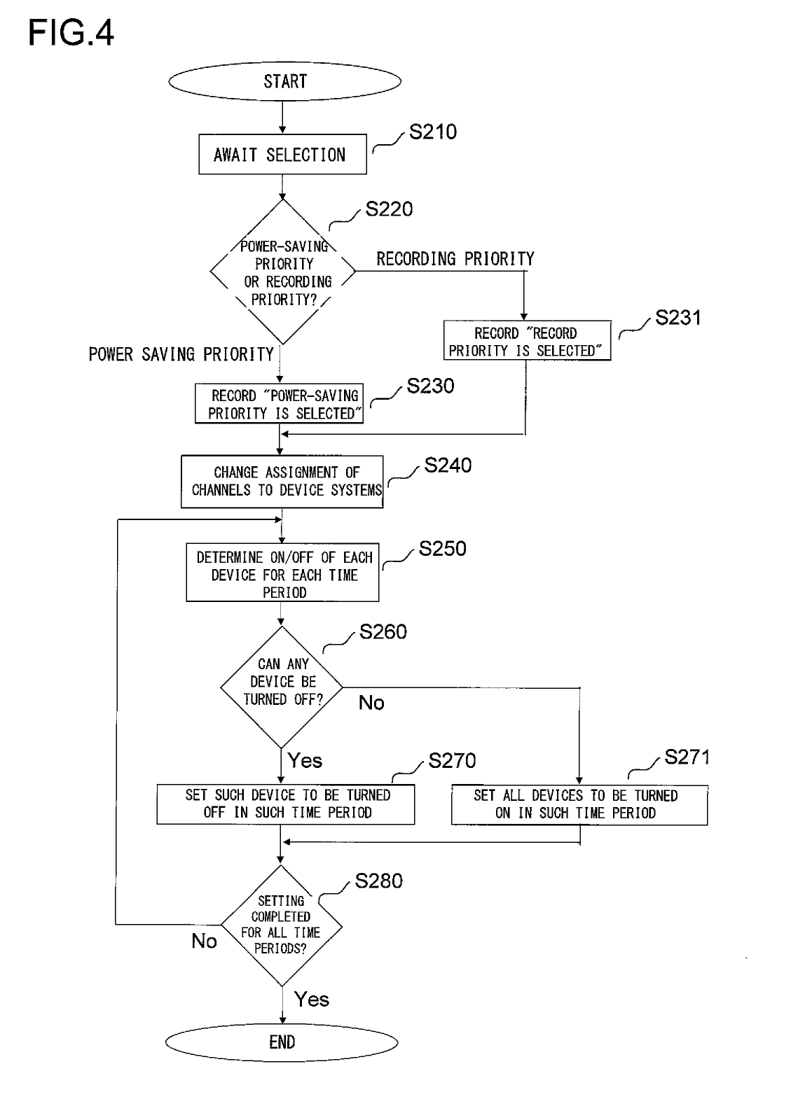

Here, the operation control processing executed by the HDD recorder 100 according to one embodiment of the present invention will be described with reference to the flow chart of FIG. 4.

A processing flow of the present embodiment starts when the setting menu is displayed according to an operation performed by the user and received by the operation input unit 22, and also the setting item for the power saving function in the continuous recording is selectable.

After the present processing is started, in step S210, the setting unit 21b displays a selection item related to the power saving function in the continuous recording, and waits for a selecting operation to be performed on the operation input unit 22. In the present embodiment, two selection items of “power saving priority” and “recording priority” are displayed to be selected.

Next, in step S220, the setting unit 21b branches the processing according to which of “power saving priority” and “recording priority” has been selected. In a case where no selection operation is detected for a predetermined length of time, it is desirable to end the present processing.

In a case where the selection item “power saving priority” is selected, in step S230, the setting unit 21b records information indicating that priority is put on power saving on a predetermined recording medium. On the other hand, in a case where the selection item “recording priority” is selected, in step S231, the setting unit 21b records information indicating that priority is given to recording on a predetermined recording medium.

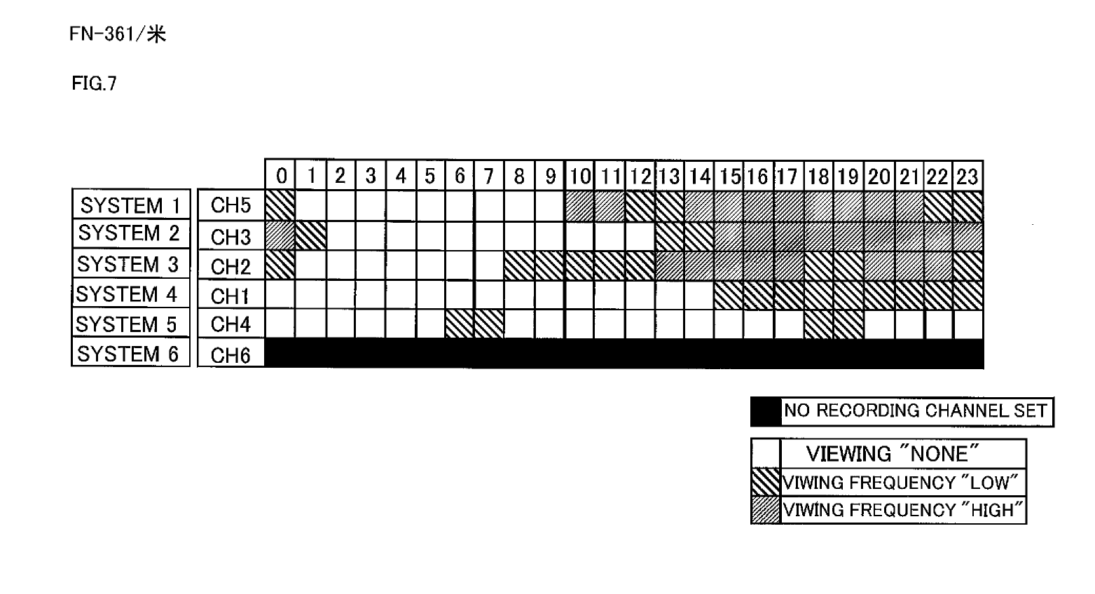

Next, in step S240, the operation control unit 21d changes the assignment of the recording channels to the device systems by using the viewing frequency table. In the present embodiment, the number of cells of “high” viewing frequency (an example of first information) is counted with respect to each recording channel, and then, the recording channels are assigned to the device systems in descending order of the number of “high” cells such that a recording channel having the largest number of “high” cells is assigned to device system 1, and a recording channel having the second largest number of “high” cells is assigned to device system Thereby, in the case of the viewing frequency table shown in FIG. 6, the assignment of the recording channels to the device systems is changed to the assignment shown in FIG. 7.

As for channels having the same number of “high” cells, one having a larger number of “low” cells is assigned to an upper device system. In the example of FIG. 7, CH5 having the largest number of “high” cells is assigned to device system 1 which is the uppermost device system. On the other hand, CH6 for which the continuous recording is not set is assigned to device system 6 which is the lowermost device system.

Thus, by changing the assignment of the channels to the device systems, a distinction is made between a recording device used for a channel of a high viewing frequency and a recording device used for a channel of low viewing frequency or of no viewing at all.

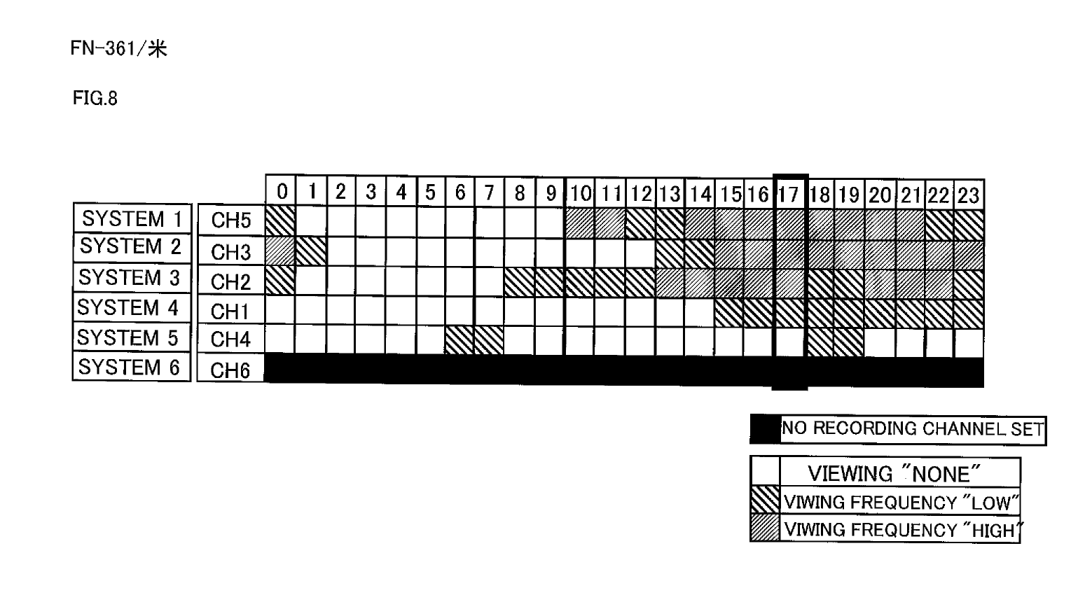

Next, in step S250, the summarization unit 21c determines whether each device included in the recording device group 10 should be turned on or off with respect to each unit time period (one hour, in this embodiment). Here, a description will be given, taking as an example a case where the ON/OFF determination is performed with respect to the “17:00” time period which is enclosed in a thick-line rectangle as shown in FIG. 8.

In a case where it is recorded, in step S230, that priority is given to power saving, a device system corresponding to a cell where the viewing frequency is “low” or “none” or a cell of “no recording channel set” (an example of second information) is regarded as a target device system whose power supply is to be turned off. In the time period of “17:00”, device system 4, device system 5, and device system 6 meet these conditions. Thus, when the priority is given to power saving, device system 4, device system 5, and device system 6 are regarded as target device systems whose power supplies are to be turned off in the 17:00 time period.

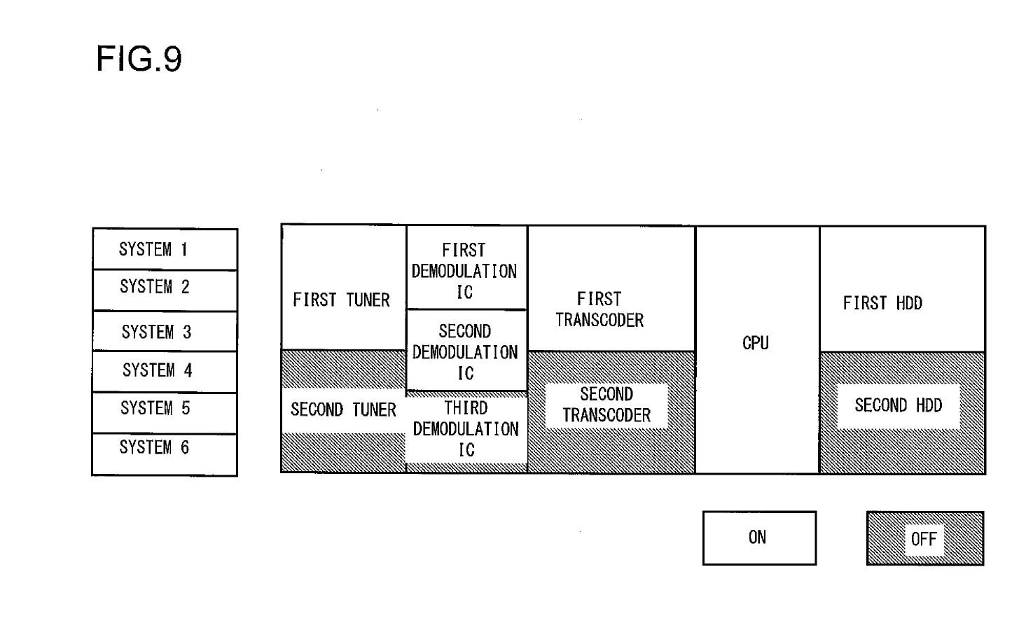

However, among recording devices included in such device systems that are regarded as target device systems whose power supplies are to be turned off, the power supply of a recording device that is shared with a device system whose power supply is turned on is not turned off. As shown in FIG. 9, the second demodulation IC 12b is shared with device system 3 (ON) and device system 4 (OFF), the second demodulation IC 12b is not turned off. Likewise, the CPU 21 is not turned off; either.

On the other hand, in a case where it is recorded, in step S231, that priority is given to recording, a device system corresponding to a cell where the viewing frequency is “none” or a cell of “no recording channel set” (an example of second information) is regarded as a target device system whose power supply is to be turned off. In the time period of “17:00”, device system 5 and device system 6 meet these conditions. Thus, when the priority is given to recording, device system 5 and device system 6 are regarded as target device systems whose power supplies are to be turned off in the 17:00 time period.

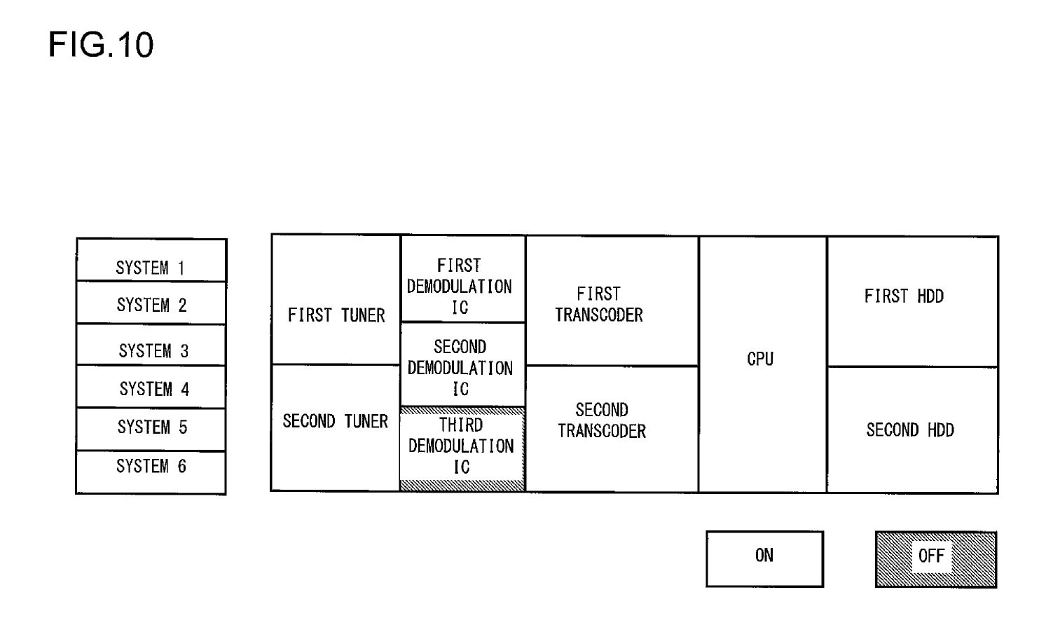

However, as shown in FIG. 10, since the second tuner group 11b, the second transcoder 13b, the CPU 21, and the second HDD 14b are shared with device system 4 (ON), these recording devices are not turned off.

Next, in step S260, the operation control unit 21 d determines, according to the result of the above determination, whether or not any of the recording devices is able to be turned off during the time period. In a case where the determination result is affirmative, in step S270, the operation control unit 21 d sets such that any target recording device is turned off in the time period. Thereafter, the operation control unit 21d controls the recording device group 10 to turn off the power supply of any target recording device each time this time period comes.

On the other hand, in a case where the determination result is negative, in step S271, the operation control unit 21d sets such that all the recording devices are turned on in the time period. Thereafter, an operation control unit 21 d controls the recording device group 10 to turn on the power supplies of all the recording devices each time this time period comes.

Next, in step S280, the operation control unit 21d determines whether or not ON/OFF settings of all the recording devices are completed with respect to all the time periods (in the example of FIG. 8, 24 time periods of from 0:00 time period to the 23:00 time period). Where the ON/OFF settings are found to have been all completed, the operation control unit 21d ends the present processing. Where the ON/OFF settings are found not to have been fully completed, the operation control unit 21d goes back to step S250 to make determination regarding whether the recording devices are to be turned on or off with respect to any undetermined time period.

According to the present embodiment discussed above, the HDD recorder 100 is provided with the recording device group 10. The recording device group 10 includes the tuner group 11 that receives broadcast waves, the demodulation IC 12 that demodulates the broadcast waves to generate recording content, and the HDD 14 on which the recording content is recorded, and the recording device group 10 also has the plurality of device systems that each perform reception, demodulation, and recording by using a reception channel. The HDD recorder 100 is also provided with the summarization unit 21c that summarizes samples indicating recording channels and recording time periods on and in which reproduced content has been recorded. Further, the HDD recorder 100 is also provided with the operation control unit 21 d that determines which recording channel is to be assigned to which device system on the basis of a sample summarization result and performs ON/OFF control of the power supplies of the recording devices included in the device systems.

On the basis of the sample summarization result, the summarization unit 21c discriminates between a cell where a counted number exceeds a threshold value and a cell where a counted number does not exceed the threshold value in the viewing frequency table. On the basis of the discrimination result, the operation control unit 21d determines which recording channel is to be assigned to which device system. Specifically, on the basis of the sampling result, the operation control unit 21d assigns the recording channels to the device systems in order of the number of samples such that a recording channel having more samples is assigned to a device system that is given higher operation priority. Then, on the basis of the operation priority and the sampling result, the operation control unit 21d determines whether to turn on or off the power supplies of the recording devices included in the device systems with respect to each of the predetermined time periods.

With the above-discussed configurations, recording is executed with respect to a time period and a channel when and where a program that suits the user's taste is likely to be broadcast. On the other hand, the continuous recording is stopped with respect to a time period and a channel when and where a program that suits the user's taste is unlikely to be broadcast, and a recording device whose power supply can be turned off is determined, and a power supply of such a recording device is turned off. Thereby, power saving can be achieved without sacrificing user-friendliness.

According to the present embodiment, the HDD recorder 100 is provided with the setting unit 21b that receives a power saving setting regarding whether priority is to be given to power saving or not. According to the power saving setting, the operation control unit 21d changes a criterion for distinction between a recording device whose power supply is to be turned on and a recording device whose power supply is to be turned off.

The above-discussed configurations allow the user to set priority settings such as “power saving priority” and “recording priority”. This makes it possible to achieve power saving that further meets the user's needs.

### Other Embodiments

Hereinabove, the present invention has been described dealing with preferable embodiments and examples, but it should be understood that the embodiments discussed above are not meant as limitations, and the present invention can be practiced with various modifications within the scope of its technical idea.

Therefore, the present invention is applicable also to the following embodiments.

(A) The above-discussed embodiments do not deal with a function of notifying the user of a result of determination on whether or not to perform continuous recording with respect to each recording channel after such determination is made, but such a notification may be issued by using, for example, the EPG. For example, a channel and a time period with respect to which no continuous recording is to be performed may be notified by, for example, greying out the channel and the time period indicated in the EPG.

(B) The above-discussed embodiments deal with devices from the tuner group 11 to the HDD 14 as examples of devices included in the recording device group 10, but the recording device group 10 may include a device other than these devices, and the operation control processing of the present embodiment may be executed with the device as a target. For example, the device group 10 may have a USB terminal to connect an external HDD thereto to record recording data of a predetermined channel on the external HDD, and a power supply to the USB terminal may be turned off in a time period when the external HDD is not used.

(C) The above-discussed embodiments deal with the HDD recorder 100 as an example of the recording and reproducing apparatus of the present invention, but the present invention may be applied to a recording and reproducing apparatus other than the HDD recorder 100. For example, the present invention may be applied to a multi-functional apparatus that performs continuous recording by using a plurality of media such as a BD medium and a semiconductor memory in addition to an HDD.

(D) In the above-discussed embodiments, the function units related to the viewing frequency determination processing and the operation control processing of the present invention are realized by executing predetermined programs on a processing unit such as a microprocessor, but they may be realized by a plurality of circuits.

(E) In the above-discussed embodiments, device system 1 is given top priority to be operated, and device system 6 is given top priority to be made to stop operating, but the device systems may regularly take turns in rotation to receive the top priority to be operated and the top priority to be made to stop operating. This makes it possible to smooth deterioration degrees of the device systems to thereby achieve a longer life of the recording device group 10.

(F) In the above-discussed embodiments, a sample is recorded each time reproduction of recorded content is detected, and collection of samples is completed at a time when a predetermined period (one month) has elapsed, but the method of collecting samples is not limited to this. For example, samples may continue to be collected even after sampling is once completed, and the sampling and update of the viewing frequency table may be performed at a predetermined timing, for example, when the power saving function of the present invention that has been turned off is turned on again.

(G) In relation to the above example, recording of a reproduction history may be continued such that, each time a piece of content recorded by the continuous recording is reproduced, a record of the reproduction is made by associating the time and date when the instruction to perform the reproduction is detected with management information of the piece of recorded content, and sample collection, sampling, and update of the viewing table may be performed at a predetermined timing (for example, at the end of each month) by referring to the reproduction history of the past one month.

What is claimed is:

1. A recording and reproducing apparatus capable of performing continuous recording, the recording and reproducing apparatus comprising:
a receiver that receives broadcasting programs;
a recorder on which the broadcasting programs received by the receiver are recorded;
a reproducer that reproduces the broadcasting programs recorded on the recorder; and
a controller that determines which broadcasting program among the broadcasting programs recorded on the recorder is reproduced by the reproducer, and controls the continuous recording on a basis of record information of the broadcasting program reproduced by the reproducer.

2. The recording and reproducing apparatus of claim 1,
wherein
the controller controls the continuous recording on the basis of broadcast time when recording of the broadcasting program reproduced by the reproducer has been performed.

3. The recording and reproducing apparatus of claim 2,
wherein
the receiver includes a plurality of tuners capable of simultaneously receiving a plurality of broadcasting programs; and
the controller controls the continuous recording on the basis of a channel on which the recording of the broadcasting program reproduced by the reproducer has been performed.

4. The recording and reproducing apparatus of claim 3,
wherein
the receiver and the recorder include a plurality of recording systems to which operational priorities are assigned;
the controller includes a summarization unit and an operation control unit;
the summarization unit summarizes history information indicating the broadcast time and the channel when and where the recording of the broadcasting program reproduced by the reproducer has been performed, and, on the basis of a result of summarizing the history information, the summarization unit classifies the history information as first information when a counted number exceeds a predetermined threshold value, and classifies the history information as second information when the counted number does not exceed the predetermined threshold value; and,
on the basis of a number of channels indicated in the first information and the operational priorities, the operation control unit determines which of the recording systems is to be assigned to a channel on which recording of a broadcasting program has been performed.

5. The recording and reproducing apparatus of claim 4,
wherein
the operation control unit assigns channels to the recording systems in descending order of frequency of appearance in the first information such that first a channel having highest frequency of appearance in the first information is assigned to a recording system among the recording systems that is highest in the operational priorities.

6. The recording and reproducing apparatus of claim 5,
wherein
the operation control unit determines whether to turn on or off a power supply of each of the recording systems with respect to each unit time period on the basis of the operational priorities and a channel indicated in the first information.

7. The recording and reproducing apparatus of claim 4, further comprising a setting unit that receives a power saving setting related to whether or not to give priority to power saving,
wherein
the operation control unit changes the threshold value according to the power saving setting.

8. The recording and reproducing apparatus of claim 4,
wherein,
the operation control unit controls the receiver and the recorder to turn on the power supply of a device that is among devices included in the recording system the power supply of which is determine to be turned off, and that is shared with the recording system the power supply of which is determined to be turned on.
